(19) United States
(12) Patent Application Publication
(10) Pub. No.: US 2008/0099092 A1
(43) Pub. Date: May 1, 2008

(54) Splitter Valve

(75) Inventors: Stephen Michael Hasko, Cambridgeshire (GB); James Robert Lowrie, Derbyshire (GB); David Anthony Clark, Cambridgeshire (GB)

Correspondence Address: NEEDLE & ROSENBERG, P.C., SUITE 1000, 999 PEACHTREE STREET, ATLANTA, GA, 30309-3915, US

(73) Assignee: MICROGEN ENERGY LIMITED, Reading, Berkshire (GB)

(21) Appl. No.: 11/664,051

(22) PCT Filed: Sep. 29, 2005
(86) PCT No.: PCT/GB05/03761

§ 371 Date: Oct. 15, 2007

(30) Foreign Application Priority Data
Sep. 29, 2004 (GB) 0421634.7

(51) Int. Cl. F16K 1/00

(52) U.S. Cl. 137/872

(57) ABSTRACT

A splitter valve comprising an outer sleeve and an inner sleeve both having orifices. The relative position of these elements determines the split of the flow. The orifices are configured so that the relative split between the two streams has a linear relationship with the relative position of the inner element and outer sleeve. A perforate plate is provided across at least one outlet to laminarise the flow.

The present invention relates to a splitter valve for splitting an inlet stream into a plurality of outlet streams, the valve comprising an inlet; a plurality of outlets, one for each outlet stream; an outer sleeve having a plurality of first outlet orifices, one for each stream; an inner element moveably retained within the outer sleeve and having an inlet and a plurality of second outlet orifices, one for each stream; wherein the relative proportion of the inlet stream fed to each outlet is determined by the relative position of the inner element and outer sleeve, and wherein the first and second outlet orifices are shaped such that the flow through each outlet varies substantially linearly with the relative position of the inner element and outer sleeve.

Such a valve will be subsequently referred to as “of the kind described” and is the subject of our earlier International application WO 2004/085893.

A valve of the kind described has been particularly designed for the gas stream of a domestic combined heat and power (dchp) system employing a linear free piston Stirling engine. However, this valve and the present invention are believed to be applicable to any situation where a fluid stream is to be divided into two or more streams.

In a dchp system employing a linear free piston Stirling engine, the engine supplies some of the domestic power and heat requirement. However, to supplement the heat output of the engine, it is necessary to provide a supplementary burner. In order to reduce the cost and space of the unit, and also to reduce the parasitic power consumption, the air intake for both the Stirling engine burner and the supplementary burner is supplied by a single fan. The air from the single fan is then divided into two streams which, having been combined with fuel, feed the two burners.

The valve of WO 2004/085893 improving to be successful for this purpose.

The present application relates to a number of improvements to a valve of the kind described.

According to a first aspect of the invention, a valve of the kind described is characterised in that a perforate member is provided across at least one outlet to at least partially laminarise the flow leaving the outlet.

This can reduce the effect of turbulence in the air leaving the or each outlet, and ensures that the flow is suitable for use with a downstream venturi or other flow metering device.

The member may be a plate or block.

The upstream face of the member is preferably concave to create a more parabolic velocity profile to improve the flow through a downstream venturi.

According to a second aspect of the present invention a valve of the kind described is characterised in that a ramp surface is provided within the inner element at the end furthest from the inlet to direct the inlet stream towards the outlet furthest from the inlet.

This ramp is provided effectively to direct the flow towards the outlet furthest from the inlet (which can be arranged to be the outlet for the highest flow) smoothly through a change of direction thereby providing a streamlined flow.

It will be appreciated that the first and second aspects of the invention may be combined thereby obtaining the combined benefits of both in terms of smoothing the flow through the valve.

According to a third aspect of the invention the valve of the kind described is characterised in that at least one of the outlet orifices has a shape which extends in a circumferential direction and is tapered along at least a portion of its length, wherein the tapering portion subtends an angle of at least 30° at the centre of the valve.

By extending the length of the tapered portion of the slot, the range of angles over which the valve operates is maximised, thereby maximising the resolution of the control system. This extended taper also prevents sudden jumps in operating conditions which might otherwise cause instability problems. Preferably, the tapering portion subtends an angle of at least 40°, and more preferably at least 45° at the centre of the valve.

According to a fourth aspect of the present invention a valve of the kind described is characterised in that a first outlet orifice has a shape which extends in a circumferential direction and is tapered along at least a portion of its length; a second outlet orifice has a shape which extends in a circumferential direction and is tapered along at least a portion of its length, wherein the two orifices taper in opposite circumferential directions, and wherein the circumferential overlap between the first and second outlet orifices subtends an angle of at least 40° at the centre of the valve.

Providing a significant overlap between the opposite facing tapers ensures a smoother flow through the valve as it switches between outlets as the pressure drop through the valve can be minimised. It will be appreciated that, the higher the pressure drop, the greater the parasitic power consumption of the fan. It is clearly better to use a greater taper overlap than reduce the fan speed to achieve the correct flow split/magnitude. The alternative, where there is minimal taper overlap, and the fan speed plays a greater part in proportioning the flows would result in a more variable range of pressure drops through the valve and an unacceptably high parasitic power consumption.

Preferably, the circumferential overlap between the first and second outlet orifices subtends an angle of at least 50°, and more preferably 60° at the centre of the valve.

It will be appreciated that the third and fourth aspects of the invention may be used independently of one another, but are also readily combinable with one another.

According to a fifth aspect of the present invention a valve of the kind described is characterised in that at least one of the outlet orifices has a tapered portion, the taper having a concave profile.

Preferably the tapered portion has a profile in which the half width, being the axial distance from a circumferential line passing through the centre of the orifice to the edge of the orifice, has a third order polynomial shape preferably defined as:

Half-width∝(0.5*θ²)+(0.5*θ³)

where θ is the angle of rotation of the valve.

This shape orifice has been established empirically and has been found to provide optimum control of the valve outlet streams. In the particular application that we are concerned with, this shape of orifice has been found to generate a better linear flow profile as compared to a straight taper. However, each application will be different and the exact polynomial depends on the flow characteristics of the other components in the system. The exact shape should therefore be determined empirically in each case.

According to a sixth aspect of the present invention a valve of the kind described is characterised in that, for each outlet, a bleed hole is provided in the inner element and is positioned so that there is flow through each outlet in all positions of the inner element.

This ensures that there is always a minimum flow to a downstream burner, even when it is not firing to purge any exhaust gases from the other burner which may otherwise find their way back through the non-active burner.

According to a seventh aspect of the present invention a valve of the kind described is characterised in that each first outlet orifice is provided with an annular seal, the seals being fitted into the outlet orifice so that its outer periphery seals against the inner periphery of the outlet orifice and the radially inner surface of the seal seals against the inner element.

These seals prevent gases leaking between the outer sleeves and inner element and allow easy relative movement between the two elements.

Although the various aspects of the present invention have been described separately, it will be appreciated that one or more of these may readily be combined in the same valve.

The present invention will now be described with reference to the accompanying drawings, in which:

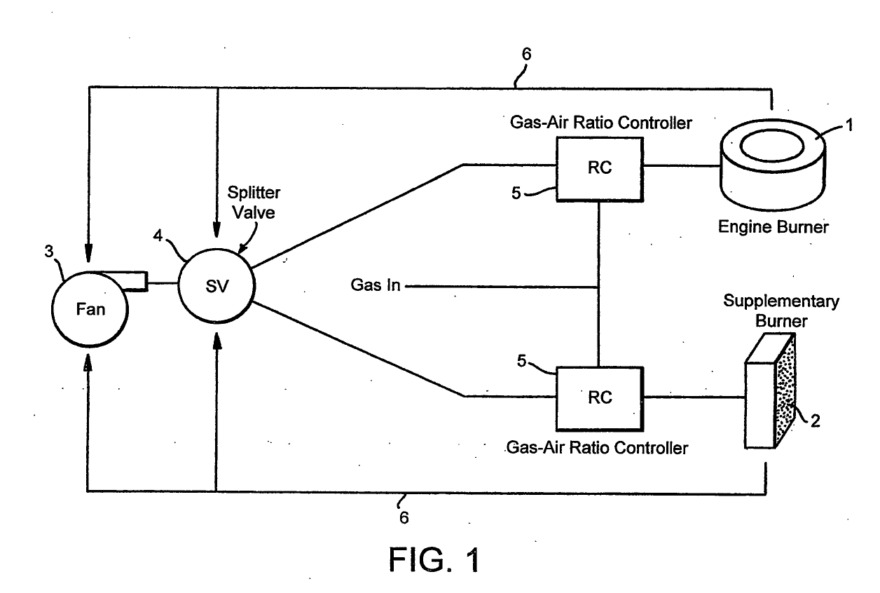

FIG. 1 is a schematic diagram of a gas train in which a splitter valve is intended to be used;

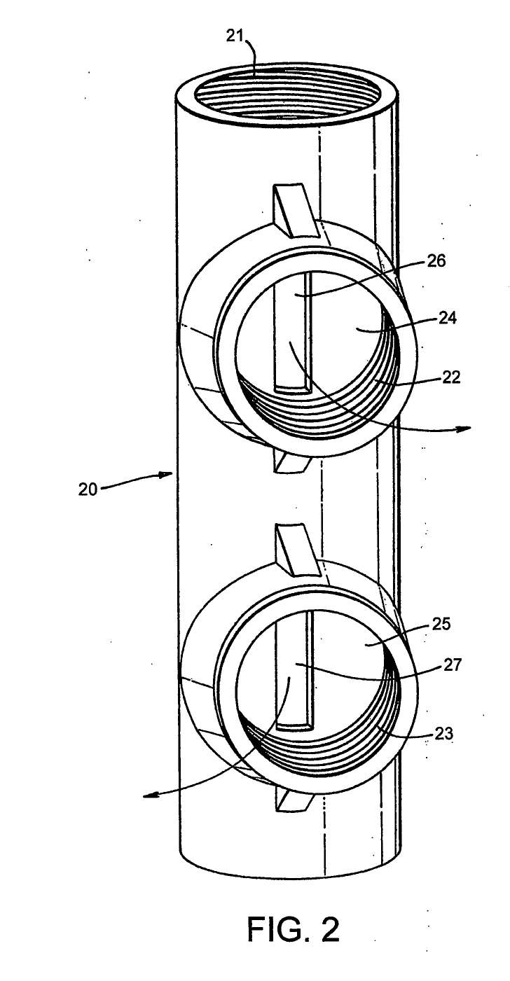

FIG. 2 is a perspective view of an outer sleeve of the valve of WO 2004/085893;

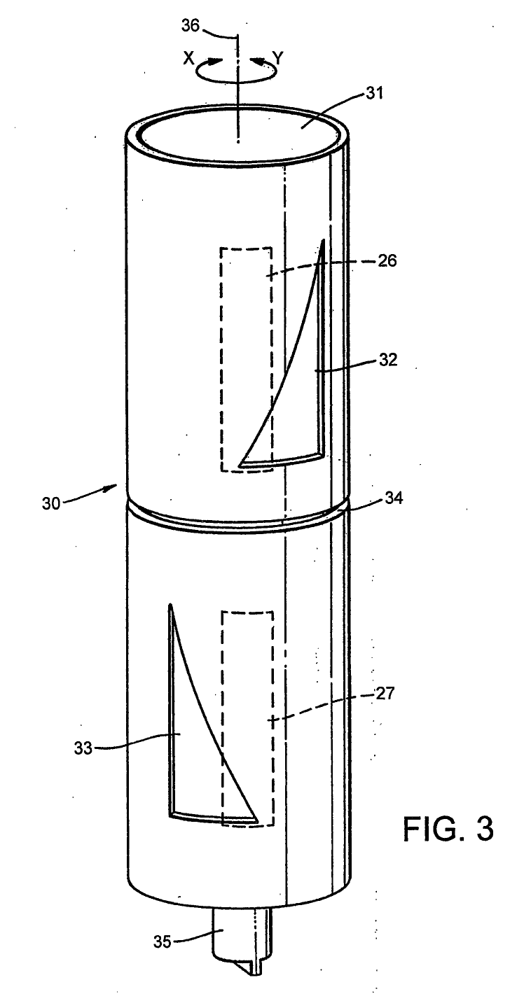

FIG. 3 is a similar perspective of an inner sleeve of the valve of WO 2004/085893;

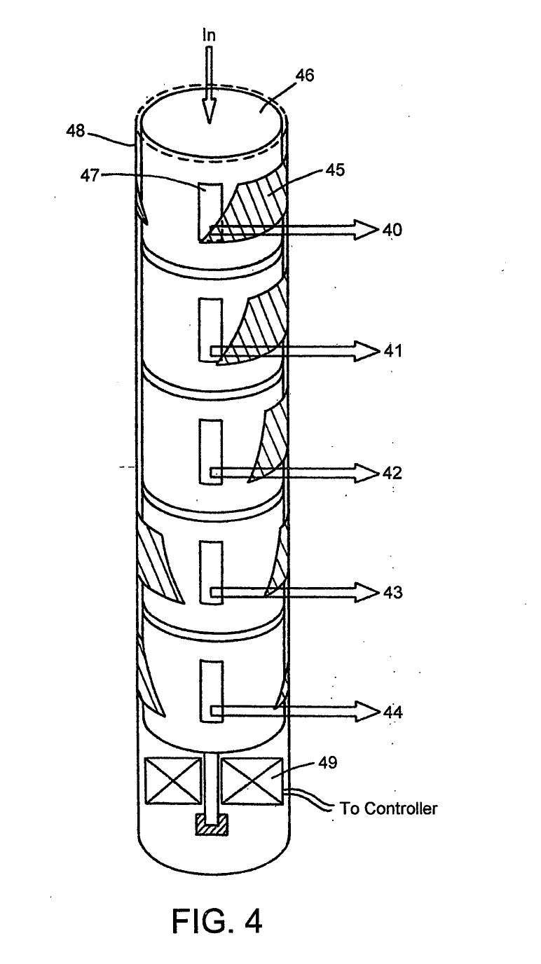

FIG. 4 is a perspective view of a splitter valve with four outlets from WO 2004/085893;

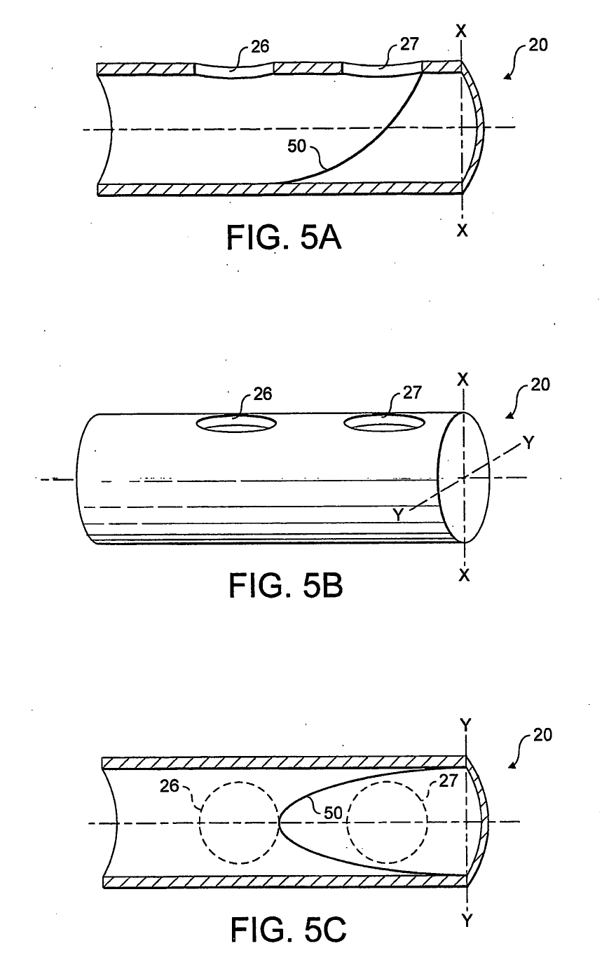

FIG. 5A is a cross section of the inner element according to second and seventh aspects of the present invention;

FIG. 5B is a perspective view of the inner element as shown in FIG. 5A;

FIG. 5C is a schematic plan view of the element shown in FIG. 5A with the top surface removed and the orifices shown in dotted lines;

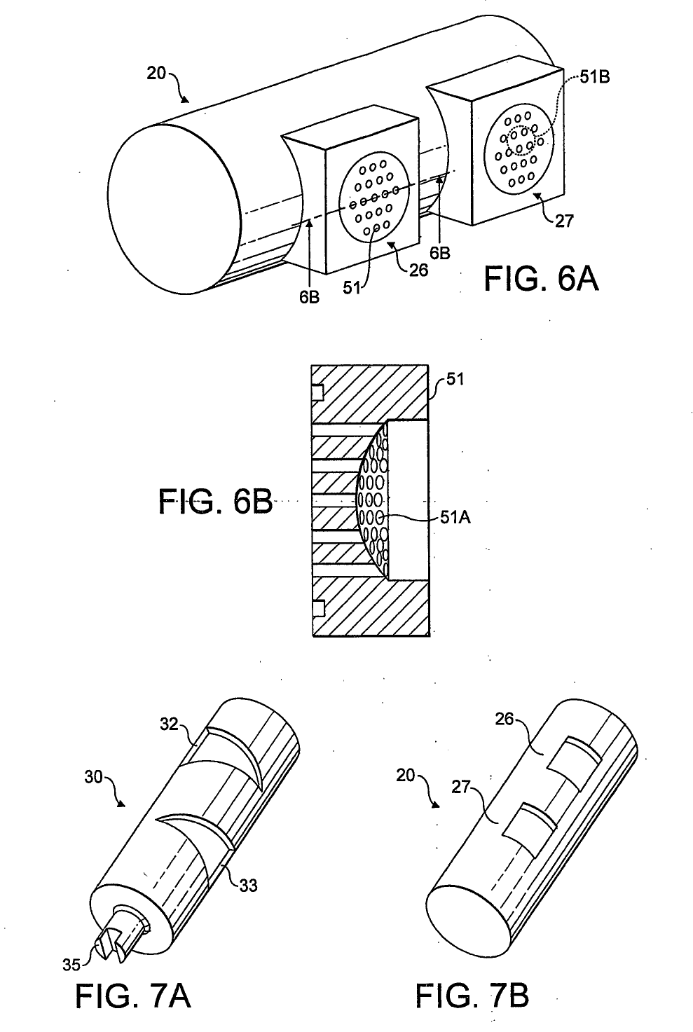

FIG. 6A is a perspective view of an outer sleeve in accordance with the first aspect of the present invention;

FIG. 6B is a cross-section through line 6B-6B in FIG. 6A;

FIG. 7A is a perspective view of the inner element in accordance with the third to sixth aspects of the invention;

FIG. 7B is a perspective view of the outer sleeve in accordance with the third to sixth aspects of the invention;

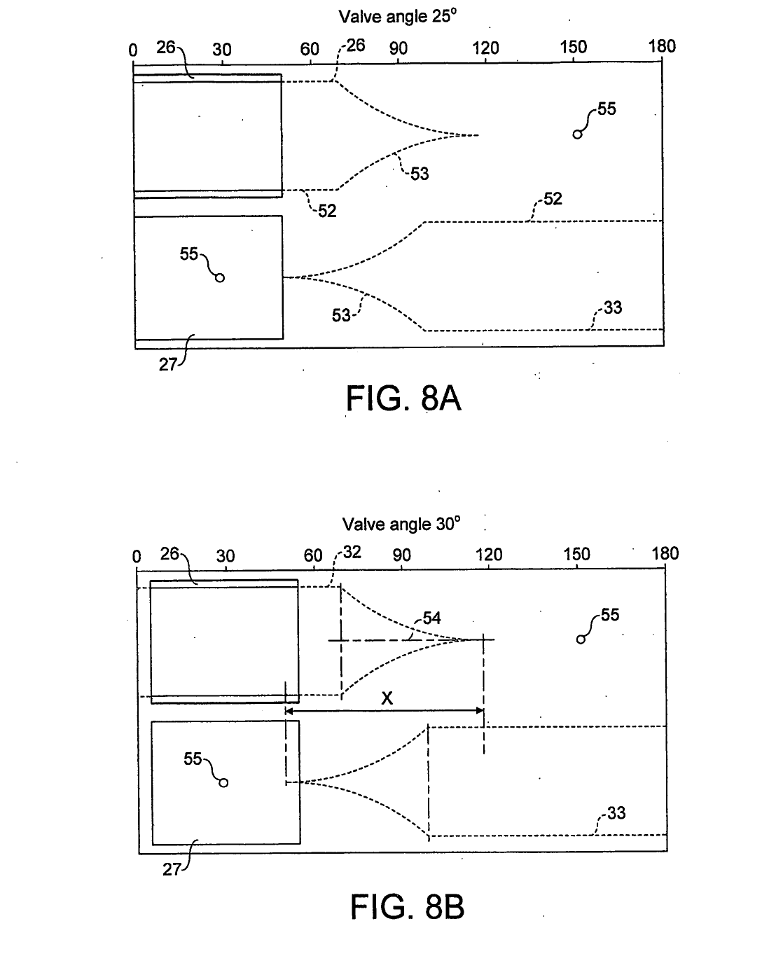

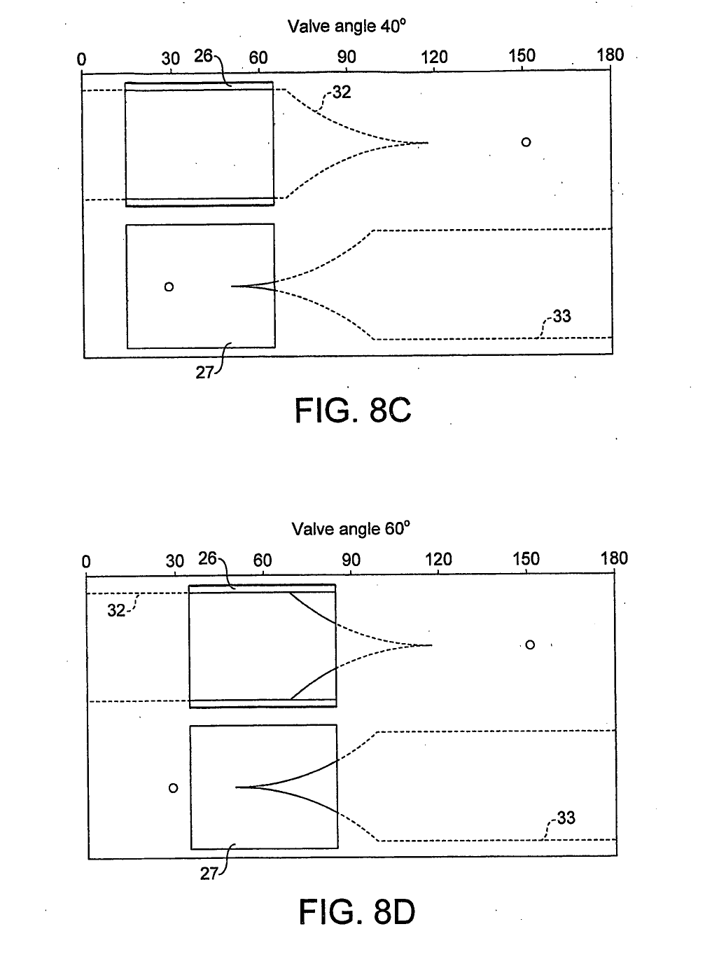

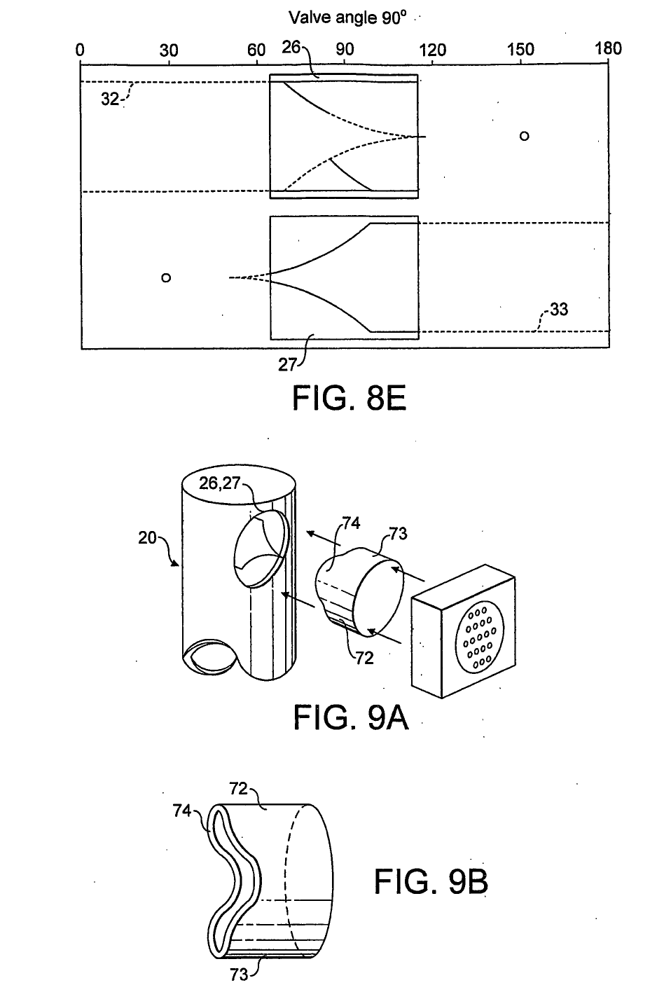

FIGS. 8A to 8E show the orifice profiles of the inner element and outer sleeve for the valve of FIGS. 7A and 7B in various relative rotational positions;

FIG. 9A is an exploded perspective of a first outlet orifice in the outer sleeve in accordance with the first and seventh aspects of the present invention; and

FIG. 9B is an enlarged perspective of the seal shown in FIG. 9A.

The basic valve to which this engine relates is described in detail in WO 2004/085893. This is described as follows with reference to FIGS. 1 to 4.

The gas train for a domestic combined heat and power assembly based on a linear free piston Stirling engine is shown in FIG. 1.

The arrangement comprises two burners, namely the Stirling engine burner 1 and supplementary burner 2. The Stirling engine burner 1 is fired according to the domestic demand for heat. As a by-product, this will also generate electricity. However, in order to ensure that there is sufficient capacity to supply all of the domestic heat load, the supplementary burner 2 is provided. The two burners are therefore modulated according to the domestic heat requirement. Air to the burners is supplied from a single fan 3. This stream is split in a splitter valve 4 which is described in greater detail below. Combustible gas is added to each of the air streams under the control of gas/air ratio controllers 5. Information about the demands of the burners 1,2 is fed along control line 6 to the fan 3 and splitter valve 4. The speed of the fan 3 and the position of the splitter valve 4 are controlled accordingly, such that the requirements of the two burners can be satisfied independently. For example, if the engine burner 1 is fully active and the supplementary burner 2 is off, the fan will be operated at an intermediate speed and the splitter valve will ensure that all of the air (subject to a possible purge flow) is fed to the engine burner. If both burners are fully active, the fan will operate at maximum speed and the splitter valve will split the flow between the two burners according to their demands.

The splitter valve will be described in greater detail with reference to FIGS. 2 and 3. FIG. 2 shows an outer sleeve 20 while FIG. 3 shows an inner sleeve 30 which, in use, is rotatably received within outer sleeve 20. Outer sleeve 20 has a screw threaded connection 21 which provides an inlet port in communication with the fan 3. Two similar screw threaded ports 22 and 23 corresponding to first 24 and second 25 outlets provide a connection for ducts leading to the two burners 1,2. The two outlets 24,25 are spaced axially along the sleeve and are both on the same side of the sleeve although they could be circumferentially offset. Each outlet has a first outlet orifice 26,27 which is an axially extending elongate rectangular through aperture in the wall of the outer sleeve 20.

These first outlet apertures 26,27 are shown in dashed lines in FIG. 3 for clarity.

In FIG. 3, the inner sleeve 30 is shown. The sleeve is hollow and has an inlet 31 at the end corresponding to the inlet port 21 to receive air from the fan 3. Second outlet orifices 32,33 are elongate generally triangular through orifices in the wall of the outer sleeve 30. A gas seal (not shown) is provided in an annular groove 34 in the outer wall of the inner sleeve 30 between the second outlet orifices. This prevents flow from one outlet to the other between the outer 20 and inner 30 sleeves.

The inner sleeve 30 has a spindle 35 axially extending from the end opposite to the inlet 31. This is connected to a motor (not shown) allowing the inner sleeve 30 to be rotated about axis 36. Alternatively, rotation of the inner sleeve could be effected by a solenoid/electro-magnet contained within the outer sleeve 20. This latter option would enable to the valve to be self-contained and therefore suitable for use with a fuel/air mixture which would allow the splitter valve 4 to be used downstream of the gas entry point, rather than upstream as shown in FIG. 1. A solenoid/electro-magnet arrangement is shown as 40 in FIG. 4.

The operation of the valve will now be described with particular reference to the upper outlet 24. As the inner sleeve is rotated about axis 36 in the direction of arrow X, the second orifice 32 progressively overlaps to a greater and greater degree with the first orifice 26. It will be seen that there is a non-linear relationship between the rotary position of the inner sleeve 30 and the area of overlap such that during initial interaction between the first and second orifices, the area of overlap is relatively small (as compared to the case where second orifice has a similar rectangular shape to that of the first orifice). The exact relationship is determined functionally to ensure that there is, as nearly as possible, a linear relationship between the rotational position of the inner sleeve 30 and the outlet flow. The illustrated configuration of outlets is one which is suitable for a particular purpose. However, it is envisaged that the profile will vary slightly with each particular application, and this variation will be determined by the requirements of the particular function.

A more detailed discussion of the relationship between the sizes of the orifices and the flow distribution of both streams is given in our earlier application WO 2004/081362.

It will be appreciated from FIG. 3 that as the sleeve 30 is rotated in the X direction, a greater proportion of flow is directed to the first outlet 24, while movement in the opposite Y direction causes more of the flow to be diverted to the second outlet 25.

It will be appreciated that the first and second orifices could be swapped, such that the rectangular orifice was provided on the inner sleeve and a triangular sleeve was provided on the outer sleeve. Alternatively, both orifices can be provided with a non-rectangular shape.

This valve also opens up the possibility of diverting the inlet flow to more than two orifices. FIG. 4 schematically shows five outlets 40,41,42,43,44. Second orifices 45 are provided on an inner sleeve 46 and first orifices 47 are provided on outer sleeve 48. A solenoid 49 in the lower end of the housing of the valve provides relative rotational movement between the inner 46 and outer 48 sleeves. The structure and operation of this valve is broadly similar to that of FIGS. 2 and 3, so that a detailed explanation is not required here. It will be noted, however, that each of the oblique edged second orifices 45 is offset to a different degree from the rectangular first orifices such that each relative angular position of the inner 46 and outer 48 sleeves provides a different flow to each of the outlets. Owing to the fixed relationship between the first and second sets of orifices, independent control of the outlet streams is not possible. However, this relationship is suitable, for example, for a multi-stage burner. For example, the first outlet 40 may feed the engine burner 1, while the second 41 to fifth 44 outlets may feed separate stages of the supplementary burner 2 which are required to be fired in sequence to provide different levels of heat output from the supplementary burner. This is disclosed in greater detail in co-pending PCT application WO 2004/085820.

If greater independence is required from the outlet flows, then the inner sleeve 46 could be split into two or more independently moveable inner sleeves.

The improvements in accordance with the various aspects of the present invention will now be described with reference to FIGS. 5 to 11.

FIGS. 5A to 5C illustrate an outer sleeve in accordance with the second aspect of the present invention. The outer sleeve 20 is provided with first and second outlet orifices 26, 27. The outer sleeve 20 has a ramp So which extends from the side furthest from the outlet orifices in a gradually increasing curve up to the edge of orifice 27 such that the flow flowing from left to right through the sleeve is directed smoothly towards the outlet orifice 27. The valve is preferably configured so that the orifice 27 is connected to the burner with the greater flow requirement. In other words, the valve is arranged so that the bulk of the air is directed to the outlet orifice 27.

A first aspect of the invention is shown in FIGS. 6A and 6B. Here, the outer sleeve 20 is provided, at the outlet orifice 26, 27, with perforated plates 51 which are fixed to the outer surface of the outer sleeve 20. These plates serve to smooth the flow of air through the outlet orifices 26, 27. The plates may be formed with integral through holes or the holes may be drilled as a separate step. Alternatively, the plates may be formed by attaching a number of hollow tubes together effectively forming a ‘honeycomb’ structure.

As shown in FIG. 6B the upstream surface 51A of the perforated plate 51 is concave. Effectively, this provides a shorter flow path through the plate towards the centre of the block and a longer path towards its periphery which has the effect of creating a flow profile which has higher velocity towards the centre and lower velocity towards the periphery. The flow plates 51 may be provided with a region 51B shown in FIG. 6A which is without perforations. When the inner sleeve is in a position in which its orifice only slightly overlaps with the plate 51, there is a tendency for the flow to be concentrated in the region of this overlap. By not providing any orifices in this region, the flow is more evenly distributed through the remaining orifices in the just open condition.

The third to sixth aspects of the invention are illustrated variously in FIGS. 7 and 8.

The basic valve is shown in FIGS. 7A and 7B. The inner sleeve 30 has orifices 32, 33, the shape of which is described in more detail below. The outer sleeve 20 has first and second orifices 26, 27 have a square profile.

The interrelationship between the orifices 32, 33 and 26, 27 is shown in greater detail in FIGS. 8A to 8E.

These figures show the angular extent of the two orifices and represent a planar plot of the angular extent of the orifices. The figures show the orifices from 0 to 180°, namely around half of the circumference of valve. The orifices do not extend to the opposite side of the valve. The 0° position in the figures represents the left hand edge of the orifice 32, while the 180° position represents the right hand edge of the orifice 33.

FIG. 8A represents a valve angle of 25°, FIG. 8B represents 30°, FIG. 8C represents 40°, FIG. 8D represents 60° and FIG. 8E represents 90°. The valve angle is defined as the position of the centre of orifice 26 relative to the 0° mark.

The orifices 26, 27 have a square profile. The orifices 32, 33 have a parallel sided portion 52 and a tapered portion 53 having concave sides in accordance with a fourth aspect of the invention. The tapered portions 53 of the two orifices extend in opposite directions.

Each taper 53 extends for approximately 50° in accordance with the third aspect of the invention. The angular overlap of the orifices 32, 33 (shown as dimension X in FIG. 8B) is approximately 70° in accordance with the fourth aspect of the invention.

Tapered profile 53 has a shape which follows a third order polynomial. The half width of the orifice, i.e. the axial distance from the centre line 54 (FIG. 8B) to the edge of the orifice is defined as:

Half-width∝(0.5*θ²)+(0.5*θ³),

where θ is the valve angle measured from the tip of the taper.

A bleed hole 55 is provided in the inner sleeve 30 for each orifice 26, 27.

The flow through the valves will now be described with reference to FIGS. 8A to 8E. The parts of the drawing shown in dark shading represent the open areas of the outlets.

In FIG. 8A the orifice 26 overlaps with the parallel sided portion 52 of orifice 32 such that the first outlet is fully open. On the other hand, the orifice 27 does not overlap the orifice 33 at all but instead only overlaps the bleed hole 55. There is therefore minimal flow through the second outlet.

As the orifices 26, 27 move to the right as shown in FIGS. 8B and 8C (which is actually effected by movement of the inner sleeve 30 in the opposite direction), full flow is maintained through the first outlet as the orifice 26 still overlaps the parallel sided portion 52 of orifice 32. However, the orifice 27 begins to overlap with the tapered portion 53 of orifice 33 so that the flow through second outlet begins to increase. As the inner sleeve 30 moves further as shown in FIGS. 8D and 8E the orifice 26 beings to overlap with the tapered portion 53 of orifice 32 thereby reducing the flow through the first outlet, while the flow through the second outlet increases further.

FIG. 8E shows the valves in a central position. It will be appreciated that, from there, continued movement effectively causes the reverse of the flow shown in FIGS. 8A to 8D until the first outlet is closed, with the exception of a bleed flow, and the second outlet is fully opened when the orifices 26, 27 reach the right hand extremity of their travel.

FIGS. 9A and 9B show a seal in accordance with the seventh aspect of the present invention. The seal 72 is fitted into an outlet orifice 26, 27 in the outer sleeve 20. The seal has an annular configuration as shown in FIG. 11B in which the outer surface 73 fits into and seals with a first outlet orifice 26, 27. The radially innermost face 74 projects into the outer sleeve 20 and has a curved configuration which seals against the inner sleeve 30. As shown in FIG. 11A, a perforate plate 51 may be provided over the seal 72. As an alternative to the seals, a tight tolerance can be provided between the outer 20 and inner 30 sleeves, thereby removing the need for the seals 72. This arrangement could also remove the need for the bleed hole 55 as the bleed flow dan be provided by the low level of flow between the sleeves.

1. A splitter valve for splitting an inlet stream into a plurality of outlet streams, the valve comprising an inlet; a plurality of outlets, one for each outlet stream; an outer sleeve having a plurality of first outlet orifices, one for each stream; an inner element moveably retained within the outer sleeve and having an inlet and a plurality of second outlet orifices, one for each stream; wherein the relative proportion of the inlet stream fed to each outlet is determined by the relative position of the inner element and outer sleeve, and wherein the first and second outlet orifices are shaped such that the flow through each outlet varies substantially linearly with the relative position of the inner element and outer sleeve; characterised in that a perforate member is provided across at least one outlet to at least partially laminarise the flow leaving the outlet.

2. A valve according to claim 1, wherein the member is a plate.

3. A valve according to claim 1, wherein the member is a block.

4. A claim according to claim 1, wherein the member is concave.

5. A splitter valve for splitting an inlet stream into a plurality of outlet streams, the valve comprising an inlet; a plurality of outlets, one for each outlet stream; an outer sleeve having a plurality of first outlet orifices, one for each stream; an inner element moveably retained within the outer sleeve and having an inlet and a plurality of second outlet orifices, one for each stream; wherein the relative proportion of the inlet stream fed to each outlet is determined by the relative position of the inner element and outer sleeve, and wherein the first and second outlet orifices are shaped such that the flow through each outlet varies substantially linearly with the relative position of the inner element and outer sleeve; characterised in that a ramp surface is provided within the inner element at the end furthest from the inlet to direct the inlet stream towards the outlet furthest from the inlet.

6. A splitter valve according to claim 1, wherein a perforate plate is provided across at least one outlet to at least partially laminarise the flow leaving the outlet.

7. A splitter valve for splitting an inlet stream into a plurality of outlet streams, the valve comprising an inlet; a plurality of outlets, one for each outlet stream; an outer sleeve having a plurality of first outlet orifices, one for each stream; an inner element moveably retained within the outer sleeve and having an inlet and a plurality of second outlet orifices, one for each stream; wherein the relative proportion of the inlet stream fed to each outlet is determined by the relative position of the inner element and outer sleeve, and wherein the first and second outlet orifices are shaped such that the flow through each outlet varies substantially linearly with the relative position of the inner element and outer sleeve; characterised in that at least one of the outlet orifices has a shape which extends in a circumferential direction and is tapered along at least a portion of its length, wherein the tapering portion subtends an angle of at least 30° at the centre of the valve.

8. A splitter valve according to claim 7, wherein the tapering portions subtends an angle of at least 40° at the centre of the valve.

9. A valve according to claim 8, wherein the tapering portions subtends an angle of at least 45° at the centre of the valve.

10. A valve according to claim 7, wherein a first outlet orifice has a shape which extends in a circumferential direction and is tapered along at least a portion of its length; a second outlet orifice has a shape which extends in a circumferential direction and is tapered along at least a portion of its length, wherein the two orifices taper in opposite circumferential directions, and wherein the circumferential overlap between the first and second outlet orifices subtends an angle of at least 40° at the centre of the valve.

11. A valve according to claim 10, wherein the circumferential overlap between the first and second outlet orifices subtends an angle of at least 50° at the centre of the valve.

12. A valve according to claim 11, wherein the circumferential overlap between the first and second outlet orifices subtends an angle of at least 60° at the centre of the valve.

13. A splitter valve for splitting an inlet stream into a plurality of outlet streams, the valve comprising an inlet; a plurality of outlets, one for each outlet stream; an outer sleeve having a plurality of first outlet orifices, one for each stream; an inner element moveably retained within the outer sleeve and having an inlet and a plurality of second outlet orifices, one for each stream; wherein the relative proportion of the inlet stream fed to each outlet is determined by the relative position of the inner element and outer sleeve, and wherein the first and second outlet orifices are shaped such that the flow through each outlet varies substantially linearly with the relative position of the inner element and outer sleeve; characterised in that a first outlet orifice has a shape which extends in a circumferential direction and is tapered along at least a portion of its length; a second outlet orifice has a shape which extends in a circumferential direction and is tapered along at least a portion of its length, wherein the two orifices taper in opposite circumferential directions, and wherein the circumferential overlap between the first and second outlet orifices subtends an angle of at least 40° at the centre of the valve.

14. A valve according to claim 13, wherein the circumferential overlap between the first and second outlet orifice subtends an angle of at least 50° at the centre of the valve.

15. A valve according to claim 14, wherein the circumferential overlap between the first and second outlet orifices subtends an angle of at least 60° at the centre of the valve.

16. A splitter valve for splitting an inlet stream into a plurality of outlet streams, the valve comprising an inlet; a plurality of outlets, one for each outlet stream; an outer sleeve having a plurality of first outlet orifices, one for each stream; an inner element moveably retained within the outer sleeve and having an inlet and a plurality of second outlet orifices, one for each stream; wherein the relative proportion of the inlet stream fed to each outlet is determined by the relative position of the inner element and outer sleeve, and wherein the first and second outlet orifices are shaped such that the flow through each outlet varies substantially linearly with the relative position of the inner element and outer sleeve; characterised in that at least one of the outlet orifices has tapered portion, the taper having a concave profile.

17. A valve according to claim 16, wherein the tapered portion has a profile in which the half width, being the axial distance from a circumferential line passing through the centre of the orifice to the edge of the orifice, has a third order polynomial shape.

18. A valve according to claim 17, wherein the third order polynomial is defined as:
Half-width %(0.5*θ²)+(0.5*θ³)
where θ is the angle of rotation of the valve.

19. A splitter valve for splitting an inlet stream into a plurality of outlet streams, the valve comprising an inlet; a plurality of outlets, one for each outlet stream; an outer sleeve having a plurality of first outlet orifices, one for each stream; an inner element moveably retained within the outer sleeve and having an inlet and a plurality of second outlet orifices, one for each stream; wherein the relative proportion of the inlet stream fed to each outlet is determined by the relative position of the inner element and outer sleeve, and wherein the first and second outlet orifices are shaped such that the flow through each outlet varies substantially linearly with the relative position of the inner element and outer sleeve; characterised in that for each outlet a bleed hole is provided in the inner element and is positioned so that there is flow through each outlet in all positions of the inner element.

20. A splitter valve for splitting an inlet stream into a plurality of outlet streams, the valve comprising an inlet; a plurality of outlets, one for each outlet stream; an outer sleeve having a plurality of first outlet orifices, one for each stream; an inner element moveably retained within the outer sleeve and having an inlet and a plurality of second outlet orifices, one for each stream; wherein the relative proportion of the inlet stream fed to each outlet is determined by the relative position of the inner element and outer sleeve, and wherein the first and second outlet orifices are shaped such that the flow through each outlet varies substantially linearly with the relative position of the inner element and outer sleeve; characterised in that each first outlet orifice is provided with an annular seal, these seals being fitted into the outlet orifice so that its outer periphery seals against the inner periphery of the outlet orifice and the radially inner surface of the seal seals against the inner element.
